(19) United States
(12) Patent Application Publication
(10) Pub. No.: US 2026/0342733 A1
(43) Pub. Date: Oct. 29, 2026

(54) CONTROL PLANE POLICING SUPPORT

(71) Applicant: Mellanox Technologies, Ltd., Yokneam (IL)

(72) Inventors: Chen Rozenbaum, Beer Yakov (IL); Quentin Barrand, Zürich (CH)

(21) Appl. No.: 19/191,543

(22) Filed: Apr. 28, 2025

(51) Int. Cl. H04L 47/20; H04L 41/0894; H04L 47/11; H04L 47/22; H04L 47/2441; H04L 47/25; H04L 47/32

(52) U.S. Cl. CPC H04L 47/20; H04L 41/0894; H04L 47/11; H04L 47/225; H04L 47/2441; H04L 47/25; H04L 47/323

(57) ABSTRACT

Technologies for providing a network pipeline abstraction layer (NPAL) Control Plane Policing (CoPP) support are described. The NPAL supports a filtering network function with a CoPP policy in a network pipeline. The filtering network function classifies, using one or more criterion specified in the CoPP policy, incoming network traffic data as a traffic flow type destined for a control plane, the traffic flow type being associated with the CoPP policy. The filtering network function determines a current rate of the traffic flow type, and performs a rate-limiting action on packets of the traffic flow type responsive to the current rate exceeding a first threshold associated with the traffic flow type specified in the CoPP policy.

### TECHNICAL FIELD

At least one embodiment pertains to processing resources used to perform and facilitate operations for providing network pipeline abstraction layer (NPAL) Control Plane Policing (CoPP) support. For example, at least one embodiment pertains to processors or computing systems used to provide and enable CoPP by an acceleration hardware engine to process network traffic data directed to a control plane, according to various novel techniques described herein.

### BACKGROUND

In traditional network architectures, specialized hardware devices known as middleboxes manage various security and performance functions. Firewalls, standalone physical appliances positioned at the network's edge, scrutinized incoming and outgoing traffic according to set rules, thereby safeguarding the internal network from external threats. Load balancers, as separate hardware units, intelligently distributed incoming network and application traffic across multiple servers to prevent overload and ensure efficient resource utilization, thus enhancing application availability and performance. Intrusion Detection Systems (IDS), strategically located within the network, monitored and analyzed network traffic for signs of anomalies, attacks, or security policy violations, effectively identifying potential security breaches.

Additionally, networks utilized other middlebox functions such as Data Loss Prevention (DLP) systems to monitor and prevent unauthorized data exfiltration, virtual private network (VPN) Gateways to establish secure and encrypted connections across networks, and Wide Area Network (WAN) Optimization appliances designed to improve data transfer efficiency across wide area networks. Although essential, these middleboxes presented challenges: they required significant capital investment, occupied valuable space in data centers, and demanded specialized personnel for operation and maintenance. Scaling these network functions often meant acquiring and integrating more physical devices, which added to the complexity and cost of the network infrastructure.

### BRIEF DESCRIPTION OF DRAWINGS

Various embodiments in accordance with the present disclosure will be described with reference to the drawings, in which:

FIG. 1 is a block diagram of an integrated circuit with Control Plane Policing (CoPP) logic for protecting the integrated circuit according to at least one embodiment.

FIG. 2 is a block diagram of an example computing system with a data processing unit (DPU) having an network pipeline abstraction layer (NPAL) for providing CoPP support in an optimized and accelerated network pipeline to be accelerated by an acceleration hardware engine according to at least one embodiment.

FIG. 3 is a network diagram of an example network pipeline that is optimized and accelerated on an acceleration hardware engine of a DPU having an NPAL according to at least one embodiment.

FIG. 4 is a network diagram of an example network pipeline that is optimized and accelerated on an acceleration hardware engine of a DPU having an NPAL according to at least one embodiment.

FIG. 5 is a network diagram of an example network pipeline that is optimized and accelerated on an acceleration hardware engine of a DPU having an NPAL according to at least one embodiment.

FIG. 6 is a flow diagram of an example method of rate limiting incoming network traffic data directed to a control plane using a NPAL with CoPP support according to at least one embodiment.

FIG. 7 is a block diagram of a software stack of a DPU with an NPAL that supports CoPP according to at least one embodiment.

FIG. 8 is a block diagram of a computing system having two processing devices coupled to each other and multiple networks according to at least one embodiment.

FIG. 9 is a block diagram of a computing system having a central processing unit (CPU) and a graphics processing unit (GPU) in a single integrated circuit according to at least one embodiment.

FIG. 10 is a block diagram of a computing system having tensor core graphics processing units (GPUs) according to at least one embodiment.

### DETAILED DESCRIPTION

Technologies for providing NPAL CoPP support are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, in traditional network architectures, various security and performance functions were managed by specialized hardware devices known as middleboxes (e.g., firewalls, load balancers, IDSs, etc.). Traditional networks were designed with the assumption that all resources would be housed within an on-premises data center, and often characterized by a centralized model.

Modern networks are increasingly cloud-centric, designed to support cloud services and applications. This includes the use of public, private, and hybrid cloud infrastructures, requiring networks to be more flexible and scalable. Unlike traditional network architectures that rely heavily on physical hardware (i.e., each network function requires its own dedicated device), current network architectures leverage virtualization technologies, such as software-defined networking (SDN) and network function virtualization (NFV). These allow network resources to be abstracted from hardware, providing greater flexibility, easier management, and reduced costs. Modern networks increasingly use automation and orchestration tools to manage network resources efficiently, reduce operational overhead, and enable faster deployment of network services. Modern networks are designed for scalability and high performance, utilizing technologies like edge computing to process data closer to the source and reduce latency. Current network architectures are more flexible, scalable, and efficient than traditional ones, designed to support the dynamic and distributed nature of modern computing resources and work practices. They integrate advanced technologies like cloud services, virtualization, and automation to meet the demands of today's digital environment.

### Network Pipeline Abstraction Layer (NPAL) CoPP Support

Aspects and embodiments of the present disclosure can provide a NPAL, which is a software programmable layer, to provide an optimized network pipeline that supports different accelerated network capabilities, such as Layer-2 (L2) bridging, Layer-3 (L3) routing, tunnel encapsulation, tunnel decapsulation, hash calculations, Equal-Cost Multi-Path (ECMP) operations, static and dynamic Access Control Lists (ACLs), Connection Tracking (CT), Quality of Service (QoS) rule, Spanning Tree Protocol (STP), virtual local area network (VLAN) mapping, network address translations (NATs), software-defined networking (SDN), multi-protocol label switching (MPLS), etc. That is, the NPAL is an accelerated programmable network pipeline to provide an abstraction of the underlying functionality of a network pipeline that is optimized for hardware acceleration on the DPU hardware. The NPAL can be, or similar to, a database abstraction layer (DAL). DAL is a programming concept used in software engineering to provide an abstraction over the underlying database systems, allowing applications to interact with different databases, low-level software layers or hardware directly without needing to change the application code. The DAL typically includes a set of applications programming interfaces (APIs) or classes that provide a unified interface for performing common database operations, such as querying, inserting, updating, and deleting data. By using the DAL, developers can write database-independent code, reducing the coupling between the application and the specific database implementation. Similarly, the NPAL can include a set of APIs or classes that provide a unified interface for performing common networking operations in a network pipeline that is optimized for hardware acceleration on the DPU hardware. In particular, the NPAL can provide a unified interface to one or more applications, network services, or the like, executed by the DPU or host device. NPAL can provide an optimized network pipeline that supports multiple network protocols and functionalities. The network pipeline can include a set of tables and logic in a specific order, the network pipeline being optimized to be accelerated by the DPU hardware, providing customers and users a rich set of capabilities and high performance.

Using an NPAL in the DPU can provide various benefits, including operational independence, encapsulation of logic, performance, code reusability, platform independence, or the like. For example, developers can write agnostic code, allowing applications (e.g., network services) to work with different underlying access logic and network functionality. The NPAL can encapsulate the access or network function-related logic, making it easier to manage and maintain the codebase. systems. Changes to the schema or underlying technology can be isolated within the NPAL implementation. The NPAL can provide an optimized and high-performance pipeline to address different networking requirements and functionality. By separating access logic from application logic, developers can reuse the NPAL components across multiple parts of the application (network service), promoting code reuse and maintainability. The NPAL can abstract away platform-specific differences, data types, and other access or network function-related features, enabling the application (network service) to run on different platforms and environments seamlessly. Overall, the NPAL can be a powerful tool for building flexible, scalable, and maintainable network function-driven applications, offering a level of abstraction that simplifies interactions between network functions and promotes code efficiency and portability.

In at least one embodiment, the DPU includes DPU hardware, including a processing device and an acceleration hardware engine. The DPU includes memory operatively coupled to the DPU hardware. The memory can store DPU software including an NPAL that supports multiple network protocols and network functions in a network pipeline. The network pipeline includes a set of tables and logic organized in a specific order to be accelerated by the acceleration hardware engine. The acceleration hardware engine can process network traffic data using the network pipeline. The network pipeline can be optimized for network services running on the DPU.

Aspects and embodiments of the present disclosure can provide and enable CoPP support in the NPAL to protect a control plane of a network device. CoPP is a network security mechanism designed to protect the control plane of network devices, such as NICs, DPUs, routers, or switches, from being overwhelmed by intense control protocol traffic or potentially malicious traffic. The control protocol traffic can be dynamic routing protocols (e.g., Open Shortest Path First (OSPF), Border Gateway Protocol (BGP), Address Resolution Protocol (ARP), Intermediate System to Intermediate System (IS-IS), etc.). CoPP operates by defining specific policies that regulate and filter traffic destined for the control plane, ensuring only legitimate traffic is processed while excessive or malicious traffic is dropped or rate-limited. The control plane processes protocol messages (e.g., BGP, OSPF, ARP), management traffic (e.g., Secure Shell (SSH), Simple Network Management Protocol (SNMP), and other essential functions like routing updates and Internet Control Message Protocol (ICMP) packets. Unregulated access to the control plane can result in overloads causing degraded performance or outages.

CoPP uses Committed Information Rate (CIR) and Excess Information Rate (EIR) configurations to police different types of traffic. CIR represents the minimum guaranteed bandwidth a traffic flow can use, with packets within CIR considered “green” and forwarded without rate limitation. EIR allows burst traffic above CIR, but with lower priority. Traffic exceeding CIR but within CIR+EIR is considered “yellow” and may be transmitted if bandwidth is available, or dropped/marked with lower priority (e.g., Explicit Congestion Notification (ECN), Differentiated Services Code Point (DSCP), or Class of Service (COS) bits) if congestion occurs. Traffic exceeding CIR+EIR is dropped, classified as “red.”

As described above, traffic is typically classified into three colors based on CIR and EIR as set forth in the following Table 1.

| Color | Traffic specified sampling Rate | Action |
|---|---|---|
| Green | Traffic ≤ CIR | Forwarded (Guaranteed) |
| Yellow | CIR < Traffic ≤ CIR + EIR | Forwarded if no congestion, |
| | | else dropped/marked |
| Red | Traffic > CIR + EIR | Dropped |

If traffic exceeds CIR+EIR, it is dropped (red packets). If traffic is above CIR but within CIR+EIR, it might be transmitted or marked.

In practice, CoPP involves classification, policing, and action. Traffic destined for the control plane is classified based on various criteria, including, for example, protocol type (e.g., SSH, BGP, OSPF), IP address, Layer-4 (L4) ports, or physical port. Each traffic type is assigned a policy that includes rate limits (CIR and EIR). Traffic exceeding the defined limits is dropped or rate-limited to protect the control plane, while legitimate traffic within the policy is forwarded for processing. Excessive or unauthorized traffic is either rate-limited or dropped.

CoPP can be used to protect against security threats like Distributed Denial of Service attacks (DDOS attacks) by limiting the number of ICMP or User Datagram Protocol (UDP) packets processed. CoPP can also be used to prioritize important protocols, ensuring important protocols like BGP or OSPF receive higher priority over less critical traffic. CoPP can also be used to safeguard management interfaces (e.g., SSH, SNMP) from unauthorized or excessive traffic. CoPP can also be used to mitigate broadcast storms by rate-limiting ARP packets to the control plane. It offers advantages such as protection from overloads, improved network stability, traffic filtering, and customizable policies. CoPP policies are executed on the DPU, accelerated by DPU hardware, and integrated into the NPAL pipeline for enhanced network security and performance.

CoPP offers numerous advantages that enhance network security and performance. One key benefit is the protection from overloads, which shields the control plane from excessive or malicious traffic, thereby preventing CPU resource exhaustion. Additionally, CoPP improves network stability by ensuring that essential control protocols, such as BGP and OSPF, are consistently processed, maintaining robust network connectivity. Another advantage is traffic filtering; CoPP prevents unauthorized traffic from reaching the control plane, thus enhancing security. Furthermore, CoPP allows for customizable policies, enabling administrators to define policies tailored to their specific network requirements.

In at least one embodiment, the DPU includes DPU hardware, including a processing device and an acceleration hardware engine. The DPU includes memory operatively coupled to the DPU hardware. The memory can store DPU software including an NPAL that supports CoPP policies in a network pipeline for enhanced network security and performance. The network pipeline includes a set of tables and logic organized in a specific order to be accelerated by the acceleration hardware engine. The acceleration hardware engine can process network traffic data using the network pipeline. The network pipeline can be optimized for network services running on the DPU.

### Data Processing Units (DPUS)

In modern network architectures, a DPU can be used to provide a set of software-defined networking, storage, security, and management services at a data-center scale with the ability to offload, accelerate, and isolate data center infrastructure. The DPU can offload processing tasks that a server's central processing unit (CPU) normally handles, such as any combination of encryption/decryption, firewall, transport control protocol/Internet Protocol (TCP/IP), and HyperText Transport Protocol (HTTP) processing, networking operations. A DPU can be an integrated circuit or a System on a Chip (SoC) that is considered a data center infrastructure on a chip. The CPU can include DPU hardware and DPU software (e.g., software framework with acceleration libraries). The DPU hardware can include a CPU (e.g., a single-core or multi-core CPU), one or more hardware accelerators, memory, one or more physical host interfaces that operatively couple to one or more host devices (e.g., a CPU of a host device), and one or more physical network interfaces that operatively couple to a network (e.g., a public network (e.g., the Internet), a private network (e.g., a local area network (LAN) or wide area network (WAN)), a wired network (e.g., Ethernet network), a wireless network (e.g., a 802.11 network or a Wi-Fi network), a cellular network (e.g., a Long Term Evolution (LTE) network), routers, hubs, switches, server computers, network adapters, NVLink switches, and/or a combination thereof). The DPU can handle network data path processing of network traffic data, whereas a host device can control path initialization and exception processing. The acceleration hardware engine (e.g., DPU hardware) can be used to offload and filter network traffic based on predefined filters using the hardware capabilities of the acceleration hardware engine. The software framework and acceleration libraries can include one or more hardware-accelerated services, including a hardware-accelerated service (e.g., NVIDIA DOCA), hardware-accelerated virtualization services, hardware-accelerated networking services, hardware-accelerated storage services, hardware-accelerated artificial intelligence/machine learning (AI/ML) services, hardware-accelerated service, and hardware-accelerated management services.

A DPU can provide accelerated networking services (also referred to as Host Based Network service (HBN) service to one or more host devices. The DPU network services can be used for accelerating L2 protocols, L3 protocols, tunneling protocols, or the like, on the DPU hardware. The HBN infrastructure is based on SFC topology, where a single virtual bridge (e.g., Open vSwitch (OVS) bridge) is controlled by the HBN service, providing all accelerated networking capabilities. The HBN service can support different protocols and different network capabilities, such as Access Control Lists (ACLs), an Equal-Cost Multi-Path (ECMP), tunneling, Connection Tracking (CT), Quality of Service (QoS) rule, Spanning Tree Protocol (STP), virtual local area network (VLAN) mapping, network address translations (NATs), software-defined networking (SDN), multi-protocol label switching (MPLS), etc.

From SW perspective, the NIC/DPU needs to support CoPP in all software stacks, including the NIC/DPU firmware (FW), drivers, a virtual bridge (or virtual switch), and the NPAL on top of the virtual bridge (or virtual switch). The NPAL can be used to configure different CoPP policies for different control protocol types. As described herein, the NPAL includes a set of tables in specific order and logic which is optimized to be accelerated by NIC/DPU HW, providing customers and users rich set of capabilities and high performance. Once the CoPP policies are defined and configured, the network pipeline can support CoPP to protect a control plane. Also, the network pipeline can be configured with different policies per control protocol type.

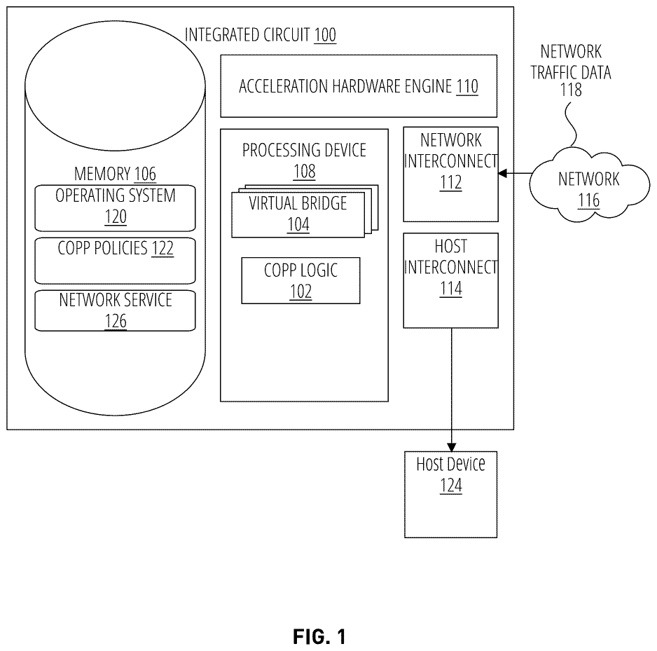

FIG. 1 is a block diagram of an integrated circuit 100 with CoPP logic for protecting the integrated circuit 100 according to at least one embodiment. The integrated circuit 100 can be a DPU, a NIC, a Smart NIC, a network interface device, or a network switch. The integrated circuit 100 includes a memory 106, a processing device 108, acceleration hardware engine 110, a network interconnect 112, and a host interconnect 114. The processing device 108 is coupled to the memory 106, the acceleration hardware engine 110, the network interconnect 112, and the host interconnect 114. The processing device 108 can host one or more the virtual bridges 104. A virtual bridge 104 (also referred to as a virtual switch) is software that operates within a computer network to connect different segments or devices, much like a physical network bridge, but in a virtualized environment. It is a core component in network virtualization, enabling the connection of virtual machines (VMs), containers, and other virtual network interfaces to each other and to the physical network, simulating traditional Ethernet network functions purely in software. Virtual bridges 104 allow for the creation and management of isolated network segments within a single physical infrastructure, facilitating communication, enforcing security policies, and providing bandwidth management, all while offering the flexibility and scalability needed in dynamic virtualized and cloud environments. The virtual bridges 104 can be Open vSwitch (OVS) bridges. An OVS bridge functions as a virtual switch at the heart of the Open vSwitch architecture, enabling advanced network management and connectivity in virtualized environments. It operates by aggregating multiple network interfaces into a single logical interface, managing the traffic flow between VMs on the same physical host, as well as the external network. Unlike traditional virtual bridges, the OVS bridge supports a wide array of networking features, such as VLAN tagging, traffic monitoring with sFlow and NetFlow, Quality of Service (QoS), and Access Control Lists (ACLs), offering enhanced flexibility and control for network administrators. The OVS bridge efficiently directs network traffic, based on pre-defined policies and rules, providing an essential tool for building complex, multi-tenant cloud and data center networks.

In particular with respect to FIG. 1, the virtual bridges 104 can provide network connectivity between VMs executed on the same integrated circuit 100 or a separate host device, containers, and/or physical devices. In short, the virtual bridges 104 allows VMs on a single physical host to communicate with each other and with the external network 116. The virtual bridges 104 can emulate the functionality of a physical network switch but operates at a software level within the integrated circuit 100. The virtual bridges 104 can manage network traffic data 118, directing data packets between VMs on the same host or between VMs and the physical network using ports. These ports can be configured for various policies like security settings, QoS rules, etc. The virtual bridges 104 can segment network traffic to provide isolation between different virtual networks. The virtual bridges 104 can provide an interface between the virtualized environment and the physical network, allowing VMs to communicate outside their host. The virtual bridges 104 can support standard networking protocols and features, such as VLAN tagging, Layer-2 (L2) forwarding, Layer-3 (L3) capabilities, tunneling protocols (e.g., Virtual Extensive LAN (VXLAN), Generic Routing Encapsulation (GRE), and the Geneve protocol), flow-based forwarding, OpenFlow Support, integration with virtualization platforms (e.g., VMware, KVM, Xen, and others, enabling network connectivity for virtual machines and containers), extensibility, traffic monitoring and mirroring, security, multi-platform support (e.g., Linux, FreeBSD, Windows, etc.), and the like. For Layer-2 Switching, one or more of the virtual bridges 104 acts as a Layer-2 Ethernet switch, enabling the forwarding of Ethernet frames between different network interfaces, including virtual and physical ports. For Layer-3 Routing, one or more of the virtual bridges 104 supports Layer-3 IP routing, allowing it to route traffic between different IP subnets and perform IP-based forwarding. The virtual bridges 104 can support VLAN tagging and allow for the segmentation of network traffic into different VLANs using VLAN tagging. The virtual bridges 104 can use flow-based forwarding where network flows are classified based on their characteristics, and packet forwarding decisions are made based on flow rules, as well as enforce security policies and access control. OVS is commonly used in data center and cloud environments to provide network agility, flexibility, and automation. It plays a vital role in creating and managing virtual networks, enabling network administrators to adapt to the changing demands of modern, dynamic data centers.

In at least one embodiment, the virtual bridges 104 can use the OVS and OF technologies. The virtual bridges 104 can be controlled by a network controller (also referred to as a network service 126) to make decisions about how traffic should be routed through the network. As described herein, a network controller (e.g., SDN controller) is a centralized entity that manages flow control to the networking devices. The OF protocol can be used to interact directly with the forwarding plane of network devices, such as virtual or physical switches and routers. In at least one embodiment, the virtual bridges 104 can use flow tables that contain rules for how packets should be handled. Each flow table contains a set of flow entries. The flow entry defines what to do with packets that match certain criteria. An entry can have three parts: match fields, actions, and counters. The match fields define packet attributes to match, such as source/destination Internet Protocol (IP) addresses, Media Access control (MAC) addresses, port numbers, VLAN tags, etc. The actions can define what to do with a matching packet, such as forwarding it to a specific port, modifying fields in the packet, or dropping it. The counters can be used to keep track of the number of packets and bytes for each flow. Since the virtual bridges 104 is virtualized, the virtual bridges 104 can create rules at a software level, a data path (DP) level, and at a hardware level. A rule created at the software level is referred to as a software (SW) rule or an OF rule. A rule created at the DP level is referred to as a DP rule. A rule created at the hardware level is referred to as a hardware (HW) rule. When a SW rule is created, corresponding DP and HW rules are created. A network controller can add, update, or delete flow entries, changing the configuration settings.

In another embodiment, the virtual bridges 104 is a Standard Virtual Switch or a Distributed Virtual Switch. In another embodiment, the virtual bridges 104 is an SDN-based switch that is integrated with an SDN controller. The integrated circuit 100 can be used in data centers, cloud computing environments, development and testing environments, network function virtualization (NFV) environments, or the like. The virtual bridges 104 can be used in a data center where server virtualization is common to facilitate communication within and between servers efficiently. The virtual bridges 104 in the cloud computing environment can enable multi-tenant networking, allowing different clients to have isolated network segments. The virtual bridges 104 can allow network function virtualizations (e.g., NFVs) to be connected and managed within virtual infrastructures. Some advantages of the virtual bridges 104 is that the virtual bridges 104 can be easily configured or reconfigured without physical intervention, can reduce the need for physical network hardware and associated maintenance, offers the ability to create isolated networks for different applications or tenants. In summary, the virtual bridges 104 is a software-based device that performs the networking functionalities of a physical switch in a virtualized environment (e.g., data centers and cloud computing environments) and provides flexibility, isolation, and efficient network management in the virtualized environment.

In at least one embodiment, the integrated circuit 100 can also host one or more hypervisors and one or more virtual machines (VMs). The network traffic data 118 can be directed to the respective VM by the virtual bridges 104.

In at least one embodiment, the integrated circuit 100 stores an operating system 120 (OS 120) in memory 106. The integrated circuit 100 can execute the operating system 120 using the processing device 108. In at least one embodiment, the integrated circuit 100 stores CoPP policies 122 in memory 106. In at least one embodiment, the integrated circuit 100 stores a network service 126 in memory 106.

In at least one embodiment, a computing system includes the host device 124 and the integrated circuit 100. The integrated circuit 100 is coupled to the host device and the network 116. The integrated circuit 100 include the network interconnect 112 coupled to the network 116, and the host interconnect 114 coupled to the host device 124. The integrated circuit 100 include the acceleration hardware engine 110, and memory 106. The processing device 108 can store instructions that, when executed by the integrated circuit 100, are to provide a network pipeline abstraction layer (NPAL) that supports multiple network protocols and network functions in a network pipeline. The network pipeline includes a set of tables and logic organized in a specific order to be accelerated by the acceleration hardware engine. At least one of the network functions includes a filtering network function with the CoPP policies 122 specified in the NPAL. The filtering network function can be configured to classify, using one or more criterion specified in one of the CoPP policies 122, incoming network traffic data as a traffic flow type destined for a control plane. The traffic flow type is associated with the CoPP policy. The filtering network function can determine a current rate of the traffic flow type. The filtering network function can perform a rate-limiting action on packets of the traffic flow type responsive to the current rate exceeding at least a first threshold associated with the traffic flow type specified in the CoPP policy.

In a further embodiment, the filtering network function can determine whether there is congestion from the incoming network traffic data. The filtering network function, to perform the rate-limiting action on the packets can forward the packets of the traffic flow type responsive to there being no congestion and the current rate exceeds the first threshold or drop the packets or mark the packets with a lower priority than other packets responsive to there being congestion and the current rate exceeds the first threshold. In some cases, the first threshold is a CIR.

In a further embodiment, the filtering network function can determine whether there is congestion from the incoming network traffic data. The filtering network function, to perform the rate-limiting action on the packets can forward the packets of the traffic flow type responsive to i) there being no congestion, ii) the current rate exceeds the first threshold, and iii) the current rate does not exceed a second threshold associated with the traffic flow type specified in the CoPP policy. Or, the filtering network function, to perform the rate-limiting action on the packets can drop the packets or mark the packets with a lower priority than other packets responsive to i) there being congestion, ii) the current rate exceeds the first threshold, and iii) the current rate does not exceed the second threshold. Or, the filtering network function, to perform the rate-limiting action on the packets can drop the packets responsive to the current rate exceeding the second threshold. In some cases, the first threshold is a CIR and the second threshold is an EIR.

In at least one embodiment, the filtering network function can classify the incoming network traffic data as the traffic flow type destined for the control plane by identifying an attribute in packet headers of the incoming network traffic data. The attribute can be any attribute in a packet header. The attribute can be a destination IP address, a L4 destination port, a physical port, or the like.

In at least one embodiment, the integrated circuit 100 is a DPU, a NIC, a network adapter, a network interface device, a switch, or the like. In at least one embodiment, the CoPP logic 102 and CoPP policies 122 can be implemented in an NPAL, including a set of applications programming interfaces (APIs) or classes that provide a unified interface to one or more applications executed by the integrated circuit 100 or the host device 124 coupled to the integrated circuit 100.

As illustrated in FIG. 1, the integrated circuit 100 can include CoPP logic 102. The CoPP logic 102 can be part of the filtering network function or can be separate from the filtering network function and configure the filtering network function to classify the incoming network traffic data, determine rates, and perform rate-limiting actions as described herein. In other embodiments, the CoPP logic 102 can be implemented in processors, computing systems, CPUs, DPUs, smart NICs, IPUs, or the like. The underlying hardware can host the virtual bridges 104.

In at least one embodiment, the integrated circuit 100 can be deployed in a Data Center (DC) network or a Service Provider (SP) network. A data center (DC) network is the foundational infrastructure that facilitates communication, data exchange, and connectivity between different computational resources, storage systems, and networking devices within a data center. It is designed to support high-speed data transmission, reliable access to distributed resources, and efficient management of data flows across various physical and virtual platforms. At its core, a DC network integrates a multitude of switches, routers, firewalls, and load balancers, orchestrated by advanced networking protocols and software-defined networking (SDN) technologies to ensure optimal performance, scalability, and security. The architecture of a DC network typically includes both the physical backbone, with high-capacity cables and switches ensuring bandwidth and redundancy, and the virtual overlay, which enables flexibility, quick provisioning, and resource optimization through virtual networks. A well-designed DC network supports a range of applications, from enterprise services to cloud computing and big data analytics, by providing the infrastructure to handle the massive amounts of data, complex computations, and application workloads typical of modern data centers. It plays a crucial role in disaster recovery, data replication, and high availability strategies, ensuring that data center services remain resilient against failures and efficient under varying loads. A Service Provider (SP) network refers to the expansive, high-capacity communication infrastructure operated by organizations that offer various telecommunications, internet, cloud computing, and digital services to businesses, residential customers, and other entities. These networks are engineered to provide wide-ranging coverage, connecting numerous geographical locations, including urban centers, remote areas, and international destinations, to facilitate global communication and data exchange. The architecture of an SP network is multi-layered, incorporating a mix of technologies such as fiber optics, wireless transmission, satellite links, and broadband access to achieve widespread connectivity. Central to these networks are high-performance backbone networks, which are responsible for the high-speed transmission of massive volumes of data across long distances. On top of the physical infrastructure, SP networks deploy advanced networking technologies, including MPLS, software-defined networking (SDN), and network function virtualization (NFV), to enhance the efficiency, flexibility, and scalability of service delivery. Service Provider networks are designed to support a vast array of services, from conventional voice and data services to modern cloud-based applications and streaming services, addressing the evolving demands of consumers and businesses alike. They are crucial for the implementation of the internet, mobile communications, enterprise networking solutions, and the emerging Internet of Things (IoT) ecosystem, ensuring connectivity and accessibility to digital resources and services on a global scale.

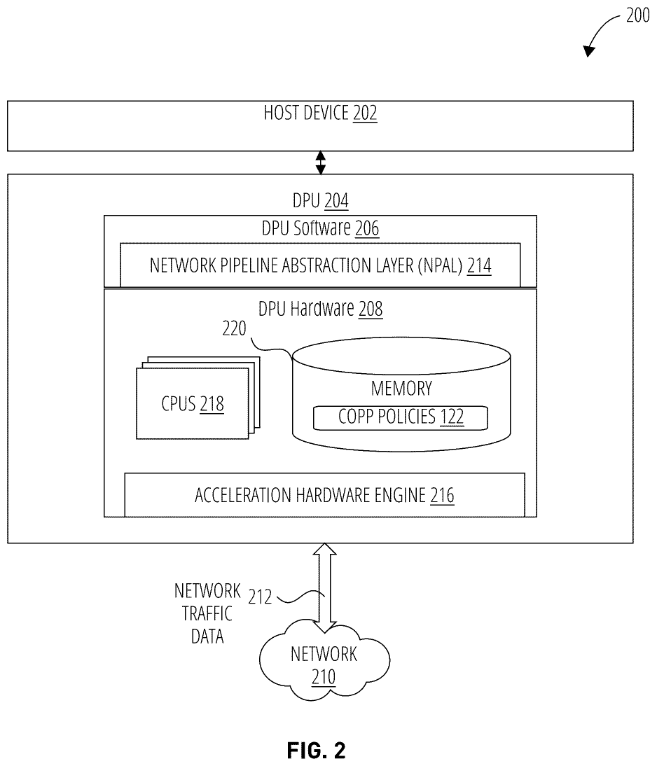

In at least one embodiment, the Copp logic 102 can be implemented as part of a hardware-accelerated service on an agentless hardware product, such as a DPU, as illustrated and described below with respect to FIG. 2. That is, the integrated circuit 100 can be a DPU. The DPU can be a programmable data center infrastructure on a chip. The hardware-accelerated service can be part of the NVIDIA OVS-DOCA, developed by Nvidia Corporation of Santa Clara, California. OVS-DOCA, which is the new OVS infrastructure for DPU, is based on the open-source OVS with additional features, new acceleration capabilities, and the OVS backend is purely DOCA based. Alternatively, the Copp logic 102 can be part of other services.

As described herein, an integrated circuit, such as a DPU can provide an NPAL with CoPP support. The NPAL is a software programmable layer that provides an optimized and accelerated network pipeline that supports different accelerated network capabilities, such as L2 bridging, L3 routing, tunnel encapsulation, tunnel decapsulation, hash calculations, ECMP operations, static and dynamic ACLs, CT, etc. The NPAL can include a set of APIs or classes that provide a unified interface for performing common networking operations in a network pipeline that is optimized for hardware acceleration on an acceleration hardware engine. The network pipeline can include a set of tables and logic in a specific order, the network pipeline being optimized to be accelerated by an acceleration hardware engine of a DPU hardware, providing customers and users a rich set of capabilities and high performance. An example DPU is illustrated and described below with respect to FIG. 2.

FIG. 2 is a block diagram of an example computing system 200 with a DPU 204 having an NPAL 214 for providing CoPP support in an optimized and accelerated network pipeline to be accelerated by an acceleration hardware engine 216 according to at least one embodiment. The computing system 200 includes the DPU 204 coupled between a host device 202 and a network 210. In at least one embodiment, the DPU 204 is a System on a Chip (SoC) that is considered a data center infrastructure on a chip. The DPU 204 is a specialized processor designed to offload and accelerate networking, storage, and security tasks from the central processing unit (CPU) of the host device 202, thus enhancing overall system efficiency and performance. The DPU 204 can be used in data centers and cloud computing environments to manage data traffic more efficiently and securely.

The DPU 204 can include a network interconnect (e.g., one or more Ethernet ports) operatively coupled to the network 210. The network interconnect can be high-speed network interfaces that enable them to connect directly to the data center network infrastructure. These interfaces can support various speeds (e.g., 10 Gbps, 25 Gbps, 40 Gbps, or higher), depending on the model and deployment requirements. The network 116 may include a public network (e.g., the Internet), a private network (e.g., a local area network (LAN) or wide area network (WAN)), a wired network (e.g., Ethernet network), a wireless network (e.g., a 802.11 network or a Wi-Fi network), a cellular network (e.g., a Long Term Evolution (LTE) network), routers, hubs, switches, server computers, and/or a combination thereof.

The DPU 204 can be coupled to a CPU of the host device 202 (or multiple host devices or servers) via one or more host interconnects (e.g., Peripheral Component Interconnect Express (PCIe)). PCIe provides a high-speed connection between the DPU 204 and the host device's CPU, allowing for the fast transfer of data and instructions. This connection is used for offloading tasks from the CPU and for ensuring that the DPU 204 can access system memory and storage resources efficiently. To enable communication between the host device 202 and the DPU 204, specialized software drivers and firmware are installed on the host device 202. These software components allow the host's operating system and applications to interact with the DPU 204, offloading specific tasks to it and retrieving processed data. In virtualized environments, the DPU 204 can also interface with hypervisors or container management systems. This allows the DPU to support multiple virtual machines (VMs) or containers by providing them with virtualized network functions, network isolation, and security features without burdening the host device's CPU. The DPU 204 can utilize Direct Memory Access (DMA) to read from and write to the host device's memory directly, bypassing the CPU to reduce latency and free up CPU resources for other tasks. This enables efficient data movement between the host memory, the DPU 204, and the network 210. In at least one embodiment, the DPU 204 includes a direct memory access (DMA) controller (not illustrated in FIG. 2) coupled to a host interface. The DMA controller can read the data from the host's physical memory via a host interface. In at least one embodiment, the DMA controller reads data from the host's physical memory using the PCIe technology. Alternatively, other technologies can be used to read data from the host's physical memory. In other embodiments, the DPU 204 may be any computing system or computing device capable of performing the techniques described herein.

Once physically connected, the DPU 204 is configured to communicate with the network 210. This involves setting up IP addresses, VLAN tags (if using virtual networks), and routing information to ensure the DPU 204 can send and receive data packets to and from other devices on the network 210. As described herein, the DPU 204 executes network-related tasks, such as packet forwarding, encryption/decryption, load balancing, and Quality of Service (QoS) enforcement. By doing so, it effectively becomes an intelligent network interface controller with enhanced capabilities, capable of sophisticated data processing and traffic management.

In at least one embodiment, the DPU 204 includes DPU hardware 208 and DPU software 206 (e.g., software framework with acceleration libraries). The DPU hardware 208 can include one or more CPUs 218 (e.g., a single-core or multi-core CPU), an acceleration hardware engine 216 (or multiple hardware accelerators), memory 220, and the network and host interconnects. In at least one embodiment, the DPU 204 includes DPU software 206, including software framework and acceleration libraries. The software framework and acceleration libraries can include one or more hardware-accelerated services, including a hardware-accelerated service (e.g., NVIDIA DOCA), hardware-accelerated virtualization services, hardware-accelerated networking services, hardware-accelerated storage services, hardware-accelerated artificial intelligence/machine learning (AI/ML) services, hardware-accelerated service, and hardware-accelerated management services.

The DPU software 1106 also includes NPAL 214. The NPAL 214 can include a set of APIs or classes that provide a unified interface for performing common networking operations in a network pipeline that is optimized for hardware acceleration on an acceleration hardware engine 216. The set of APIs or class can provide a unified interface to one or more applications, network services, or other logic executed by the DPU 204 or host device 202, or both. The network pipeline can include a set of tables and logic in a specific order, the network pipeline being optimized to be accelerated by an acceleration hardware engine 216 of the DPU hardware 208.

Using an NPAL 214 in the DPU 204 can provide various benefits, including operational independence, encapsulation of logic, performance, code reusability, platform independence, or the like. For example, developers can write agnostic code, allowing applications (e.g., network services) to work with different underlying access logic and network functionality. The NPAL 214 can encapsulate the access or network function-related logic, making it easier to manage and maintain the codebase. systems. Changes to the schema or underlying technology can be isolated within the NPAL implementation. The NPAL 214 can provide an optimized and high-performance pipeline to address different networking requirements and functionality. By separating access logic from application logic, developers can reuse the NPAL components across multiple parts of the application (network service), promoting code reuse and maintainability. The NPAL 214 can abstract away platform-specific differences, data types, and other access or network function-related features, enabling the application (network service) to run on different platforms and environments seamlessly. Overall, the NPAL 214 can be a powerful tool for building flexible, scalable, and maintainable network function-driven applications, offering a level of abstraction that simplifies interactions between network functions and promotes code efficiency and portability.

In at least one embodiment, the DPU includes DPU hardware, including a processing device and an acceleration hardware engine. The DPU includes memory operatively coupled to the DPU hardware. The memory can store DPU software including an NPAL 214 that supports multiple network protocols and network functions in a network pipeline. The network pipeline includes a set of tables and logic organized in a specific order to be accelerated by the acceleration hardware engine. The acceleration hardware engine can process network traffic data using the network pipeline. The network pipeline can be optimized for network services running on the DPU.

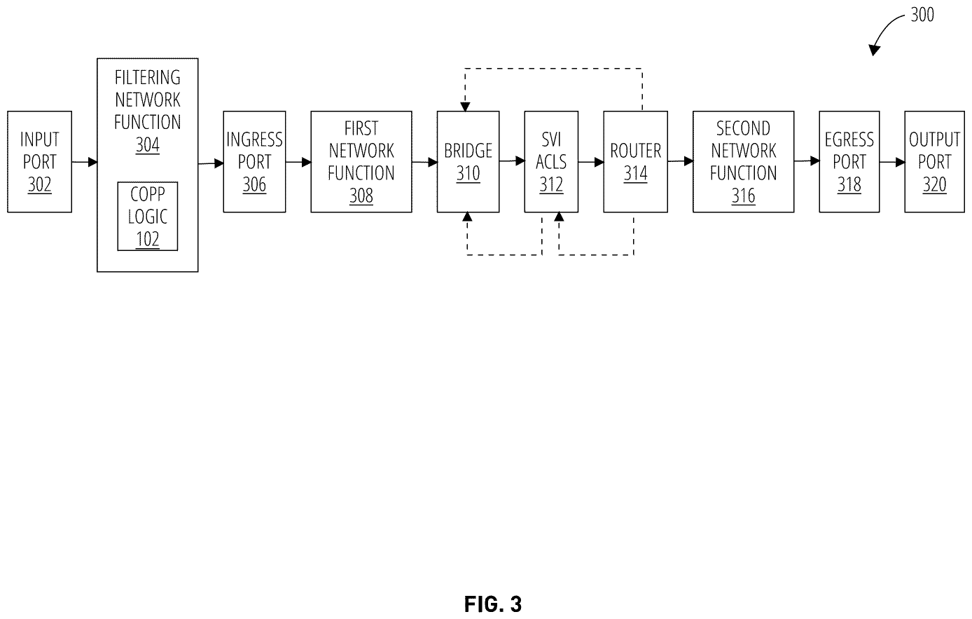

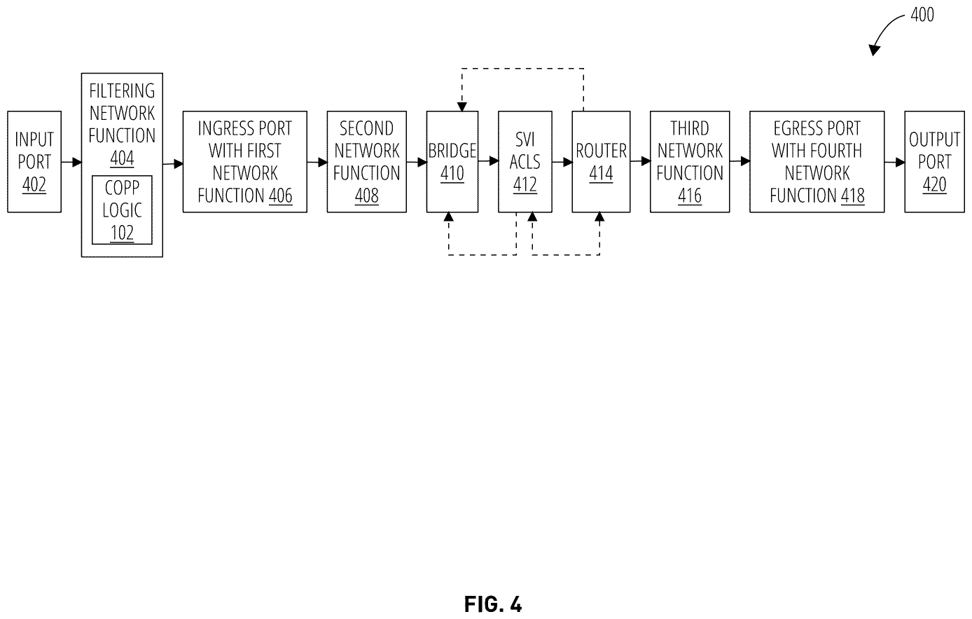

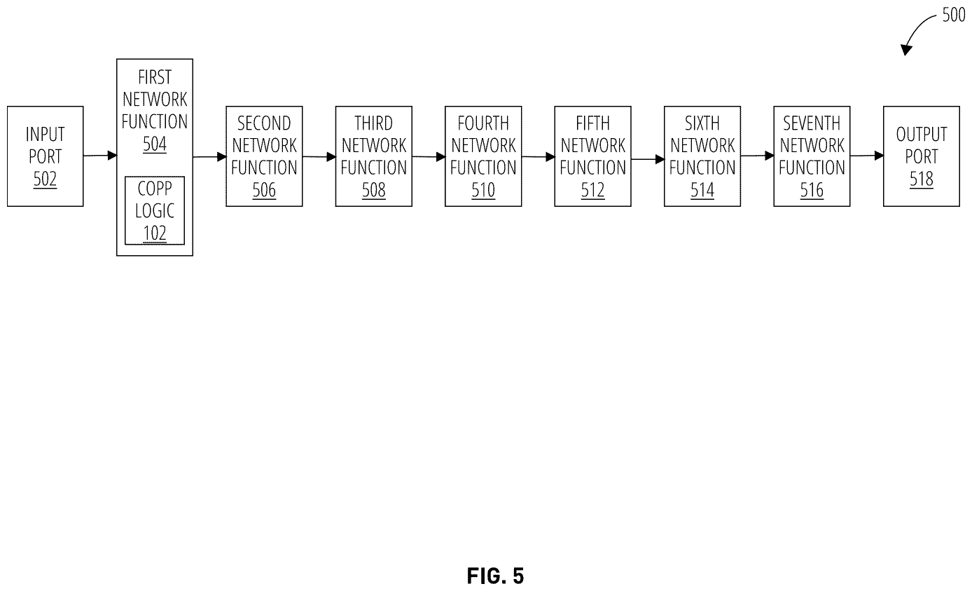

During operation, the DPU hardware 208 can receive the network traffic data 212 from the network 210 and process the network traffic data 212 using the optimized and accelerated network pipeline programmed by the NPAL 214. As described herein the NPAL 214 supports multiple network protocols and network functions in a network pipeline. The network pipeline includes a set of tables and logic organized in a specific order to be accelerated by the acceleration hardware engine 216. The acceleration hardware engine 216 can process network traffic data 212 using the network pipeline. In at least one embodiment, the network pipeline includes an input port, an ingress dynamic or static Access Control List (ACL), a bridge, a router, an egress dynamic or static ACL, and an output port. Examples of the optimized and accelerated network pipelines are illustrated and described below with respect to FIG. 3, FIG. 4, and FIG. 5.

In at least one embodiment, the memory 220 stores the CoPP policies 122. The 122 specifies one or more thresholds associated with one or more control protocol types. The thresholds can be different for different control protocol types. For example, a CPU of the one or more CPUs 218 can generate, according to the CoPP policies 122, filtering rules for an optimized and accelerated network pipeline, as described herein. The CoPP logic 102, as described above with respect to FIG. 1, can be implemented in the DPU software 206 to generate and manage filtering rules for supporting CoPP. The CoPP logic 102 can leverage the acceleration hardware engine 216 (e.g., DPU hardware 208) to offload and filter network traffic data 212 based on predefined filters using the hardware capabilities of the acceleration hardware engine 216. The DPU hardware 208 can receive network traffic data 212 over the network ports from a second device (or multiple devices) on the network 210.

In at least one embodiment, the DPU software 206 can perform several actions when creating the virtual bridges 104 and the corresponding interface mappings to ensure proper configuration and integration within the virtualized environment. The DPU software 206 can initialize the creation of a virtual bridge by allocating the resources and setting up the initial configuration parameters. These configurations can be stored in configuration files. Also, the CoPP policies 122 can be defined for different control protocol types. The configuration parameters can define the bridge name, network protocols to be supported, and any specific settings related to performance or security. A virtual network interface is created to act as the virtual bridge. This interface serves as the anchor point for all the virtual and physical interfaces that will be connected to the virtual bridge. The DPU software 206 can identify and link the designated physical (e.g., Ethernet ports) and virtual interfaces (e.g., virtual machine network adapters) to the newly created virtual bridge. This action involves configuring each interface's settings to ensure compatibility and optimal communication within the virtual bridge. The DPU software 206 can configure the networking protocols. Networking protocols and services, such as Spanning Tree Protocol (STP) for loop prevention, are configured on the virtual bridge. The DPU software 206 may also set up VLAN tagging for traffic segmentation, QoS policies for traffic prioritization, and security features like Access Control Lists (ACLs). The DPU software 206 can assign IP addresses to the bridge interfaces. If the virtual bridge acts as a Layer-3 (L3) switch, the DPU software 206 assigns IP addresses to the bridge interface, enabling it to participate in IP routing between the different connected networks or devices. The DPU software 206 can provide a unified interface to allow for centralized control and monitoring of the network. Network administrators can manage the virtual bridge alongside other virtual network components through the unified interface. The DPU software 206 can enable monitoring and management features for the virtual bridge, allowing network administrators to observe traffic flow, identify potential issues, and make adjustments, as needed, to optimize network performance and security. Throughout these steps, the software ensures that the virtual bridge is seamlessly integrated into the existing network architecture, providing a flexible and efficient way to connect various network segments within virtualized environments.

In at least one embodiment, the DPU software 206 can configure the virtual bridge to filter the network traffic data 212. For example, the CoPP policies 122 can specify what data should be extracted from the network traffic data 212 by the virtual bridge (or by filtering network function of the network pipeline). The CoPP policies 122 can specify one or more filters that extract for inclusion or remove from inclusion specified types of data from the network traffic data 212. The network traffic that meets the filtering criteria can be structured and streamed to one of the network functions for processing. For example, the CoPP policies 122 can specify that network traffic that is classified as control protocol types be rate limited according to one or more thresholds associated with each of the control protocol types.

As described herein, the NPAL 214 can provide support for different network protocols and capabilities in network functions. Different network protocols and capabilities serve as the backbone of modern networking, enabling a wide array of functionalities from basic connectivity to advanced security and traffic optimization. The network functions can include network functions, including a set of tables and logic to perform the corresponding network function, such as ACL, ECMP routing, tunneling, Connection Tracking (CT), NAT, QoS, or the like. ACLs are a fundamental network security feature that allows or denies traffic based on a set of rules. These lists are applied to network interfaces, controlling the flow of packets either at the ingress or egress point. The rules can specify various parameters such as source and destination IP addresses, port numbers, and the protocol type to finely tune the traffic filtering process, enhancing security and compliance. ECMP is a routing strategy used to distribute outgoing network traffic across multiple paths that have the same cost. By balancing the load evenly across these paths, ECMP can significantly increase the bandwidth and reliability of the network. This protocol is particularly useful in data center and cloud environments, where high availability and scalability are important. Tunneling encapsulates one protocol or session inside another protocol, allowing data to traverse networks with incompatible address spaces or architectures. It is widely used in implementing Virtual Private Networks (VPNs), where secure tunnels over the internet enable private communications. Protocols like IPsec and GRE are common examples that facilitate tunneling for security and protocol encapsulation purposes. CT refers to the ability of a network device (such as a firewall or a router) to maintain the state information of network connections passing through it. This capability enables the device to make more informed decisions about which packets to allow or block, based on the context of the session to which they belong. CT is crucial for implementing stateful firewalls and NAT (Network Address Translation) functionalities. QoS capabilities refers to mechanisms that prioritize certain types of traffic to ensure the performance of applications, especially in congested network scenarios. The network functions can include other types of network functions, such as Segment Routing (SR), Multiprotocol Label Switching (MPLS), Network Virtualization, Software-Defined Networking (SDN), or the like. SR enables the source of a packet to define the path that the packet takes through the network using a list of segments, improving the efficiency and flexibility of routing. MPLS is a method for speeding up and shaping network traffic flows, where data packets are labeled and quickly routed through pre-determined paths in the network. Network Virtualization involves abstracting physical network equipment and resources into a virtual network, allowing for more flexible and efficient resource management. Software-Defined Networking (SDN) decouples the network control and forwarding functions, enabling programmable network management and the efficient orchestration of network services. These protocols and capabilities represent just a fraction of the vast array of technologies that underlie modern networking, each playing a specific role in ensuring that data is transported efficiently, securely, and reliably across the digital infrastructure.

In at least one embodiment, the DPU 204 includes the DPU hardware 208, including a processing device and an acceleration hardware engine, and memory operatively coupled to the DPU hardware. The memory can store instructions that, when executed by the DPU hardware, are to provide the NPAL 214 that supports multiple network protocols and network functions in a network pipeline. The network pipeline includes a set of tables and logic organized in a specific order to be accelerated by the acceleration hardware engine. At least one of the network functions includes a filtering network function with the CoPP policy specified in the NPAL. The filtering network function can classify, using one or more criterion specified in the CoPP policy, incoming network traffic data as a traffic flow type destined for a control plane (also referred to as control protocol type), the traffic flow type being associated with the CoPP policy. The filtering network function can determine a current rate of the traffic flow type. The filtering network function can perform a rate-limiting action on packets of the traffic flow type responsive to the current rate exceeding a first threshold associated with the traffic flow type specified in the CoPP policy.

In at least one embodiment, the filtering network function can determine whether there is congestion from the incoming network traffic data. To perform the rate-limiting action on the packets, the filtering network function can forward the packets of the traffic flow type responsive to there being no congestion and the current rate exceeds the first threshold. Alternatively, the filtering network function can drop the packets or mark the packets with a lower priority than other packets responsive to there being congestion and the current rate exceeds the first threshold. In at least one embodiment, the first threshold is a CIR.

In at least one embodiment, the filtering network function can determine whether there is congestion from the incoming network traffic data. To perform the rate-limiting action on the packets, the filtering network function can forward the packets of the traffic flow type responsive to i) there being no congestion, ii) the current rate exceeds the first threshold, and iii) the current rate does not exceed a second threshold associated with the traffic flow type specified in the CoPP policy. Alternatively, the filtering network function can drop the packets or mark the packets with a lower priority than other packets responsive to i) there being congestion, ii) the current rate exceeds the first threshold, and iii) the current rate does not exceed the second threshold. Alternatively, the filtering network function can drop the packets responsive to the current rate exceeding the second threshold. In at least one embodiment, the first threshold is a CIR and the second threshold is EIR.

In at least one embodiment, the filtering network function can classify the incoming network traffic data as the traffic flow type destined for the control plane by identifying an attribute in packet headers of the incoming network traffic data. The attribute can be any attribute in a packet header. The attribute can be a destination IP address, a L4 destination port, a physical port, or the like.

The integration of a DPU 204 into the network 210 and the host device 202 thus represents a powerful approach to optimizing data processing tasks, significantly enhancing the performance, and security of data center and cloud computing environments. By handling a substantial portion of the networking, storage, and security workload, the DPU 204 can enable CPUs to focus more on application processing, improving overall system efficiency and throughput. For example, the DPU 204 can handle network data path processing of network traffic data 212. The CPU can control path initialization and exception processing. The DPU 204 can be part of a data center and include one or more data stores, one or more server machines, and other components of data center infrastructure. It should be noted that, unlike a CPU or a GPU, the DPU 204 is a new class of programmable processor that combines three key elements, including, for example: 1) an industry-standard, high-performance, software-programmable CPU (single-core or multi-core CPU), tightly coupled to the other SoC components; 2) a high-performance network interface capable of parsing, processing and efficiently transferring data at line rate, or the speed of the rest of the network, to GPUs and CPUs; and 3) a rich set of flexible and programmable acceleration engines that offload and improve applications performance for AI and machine learning, security, telecommunications, and storage, among others. These capabilities can enable an isolated, bare-metal, cloud-native computing platform for cloud-scale computing. In at least one embodiment, DPU 204 can be used as a stand-alone embedded processor. In at least one embodiment, DPU 204 can be incorporated into a network interface controller (also called a Smart Network Interface Card (SmartNIC)) used as a server system component. A DPU-based network interface card (network adapter) can offload processing tasks that the server system's CPU normally handles. Using its processor, a DPU-based SmartNIC may be able to perform any combination of encryption/decryption, firewall, transport control protocol/Internet Protocol (TCP/IP), and HyperText Transport Protocol (HTTP) processing. SmartNICs can be used for high-traffic web servers, for example.

In at least one embodiment, DPU 204 can be configured for traditional enterprises' modern cloud workloads and high-performance computing. In at least one embodiment, DPU 204 can deliver a set of software-defined networking, storage, security, and management services at a data-center scale with the ability to offload, accelerate, and isolate data center infrastructure. In at least one embodiment, DPU 204 can provide multi-tenant, cloud-native environments with these software services. In at least one embodiment, DPU 204 can deliver data center services of up to hundreds of CPU cores, freeing up valuable CPU cycles to run business-critical applications. In at least one embodiment, DPU 204 can be considered a new type of processor that is designed to process data center infrastructure software to offload and accelerate the compute load of virtualization, networking, storage, security, cloud-native AI/ML services, and other management services.

In at least one embodiment, the DPU 204 can include connectivity with packet-based interconnects (e.g., Ethernet), switched-fabric interconnects (e.g., InfiniBand, Fibre Channels, Omni-Path), or the like. In at least one embodiment, DPU 204 can provide a data center that is accelerated, fully programmable, and configured with security (e.g., zero-trust security) to prevent data breaches and cyberattacks. In at least one embodiment, the DPU 204 can include a network adapter, an array of processor cores, and infrastructure offload engines with full software programmability. In at least one embodiment, the DPU 204 can sit at an edge of a server to provide flexible, secure, high-performance cloud and AI workloads. In at least one embodiment, the DPU 204 can reduce the total cost of ownership and increase data center efficiency. In at least one embodiment, the DPU 204 can provide the software framework and acceleration libraries (e.g., NVIDIA DOCA™) that enable developers to rapidly create applications and services for the DPU 204, such as security services, virtualization services, networking services, storage services, AI/ML services, and management services. In at least one embodiment, the software framework and acceleration libraries make it easy to leverage hardware accelerators of the DPU 204 to provide data center performance, efficiency, and security. In at least one embodiment, the DPU 204 can be coupled to a GPU. The GPU can include one or more accelerated AI/ML pipelines.

In at least one embodiment, the DPU 204 can provide networking services with a virtual switch (vSwitch), a virtual router (vRouter), network address translation (NAT), load balancing, and network virtualization (NFV). In at least one embodiment, the DPU 204 can provide storage services, including NVME™ over fabrics (NVMe-oF™) technology, elastic storage virtualization, hyper-converged infrastructure (HCI) encryption, data integrity, compression, data deduplication, or the like. NVM Express™ is an open logical device interface specification for accessing non-volatile storage media attached via the Peripheral Component Interconnect Express® (PCIe) interface. NVMe-oF™ provides an efficient mapping of NVMe commands to several network transport protocols, enabling one computer (an “initiator”) to access block-level storage devices attached to another computer (a “target”) very efficiently and with minimum latency. The term “Fabric” is a generalization of the more specific ideas of network and input/output (I/O) channel. It essentially refers to an N:M interconnection of elements, often in a peripheral context. The NVMe-oF™ technology enables the transport of the NVMe command set over a variety of interconnection infrastructures, including networks (e.g., Internet Protocol (IP)/Ethernet) and I/O Channels (e.g., Fibre Channel). In at least one embodiment, the DPU 204 can provide hardware-accelerated services using Next-Generation Firewall (NGFW), Intrusion Detection Systems (IDS), Intrusion Prevention System (IPS), a root of trust, micro-segmentation, distributed denial-of-service (DDoS) prevention technologies, and ML detection. NGFW is a network security device that provides capabilities beyond a stateful firewall, like application awareness and control, integrated intrusion prevention, and cloud-delivered threat intelligence. In at least one embodiment, one or more network interfaces can include an Ethernet interface (single or dual ports) and an InfiniBand interface (single or dual ports). In at least one embodiment, the one or more host interfaces can include a PCIe interface and a PCIe switch. In at least one embodiment, the one or more host interfaces can include other memory interfaces. In at least one embodiment, the CPU can include multiple cores (e.g., up to 8 64-bit core pipelines) with L2 cache per two one or two cores and L3 cache with eviction policies support for double data rate (DDR) dual in-line memory module (DIMM) (e.g., Double Data Rate 4 (DDR4) DIMM support), and a DDR4 Dynamic Random Access Memory (DRAM) controller. Memory can be on-board DDR4 memory with error correction code (ECC) error protection support. In at least one embodiment, the CPU can include a single core with L2 and L3 caches and a DRAM controller. In at least one embodiment, the one or more hardware accelerators can include a security accelerator, a storage accelerator, and a networking accelerator. In at least one embodiment, the security accelerator can provide a secure boot with hardware root-of-trust, secure firmware updates, Cerberus compliance, Regular expression (RegEx) acceleration, IP security (IPsec)/Transport Layer Security (TLS) data-in-motion encryption, Advanced Encryption Standard Galois/Counter Mode (AES-GCM) 512/256-bit key for data-at-rest encryption (e.g., AES with ciphertext stealing (XTS) (e.g., AES-XTS 256/512), secure hash algorithm (SHA) 256-bit hardware acceleration, Hardware public key accelerator (e.g., Rivest-Shamir-Adleman (RSA), Diffie-Hellman, Digital Signal Algorithm (DSA), ECC, Elliptic Curve Cryptography Digital Signal Algorithm (ECC-DSA), Elliptic-curve Diffie-Hellman (EC-DH)), and True random number generator (TRNG). In at least one embodiment, the storage accelerator can provide BlueField SNAP-NVMe™ and VirtIO-blk, NVMe-oF™ acceleration, compression and decompression acceleration, and data hashing and deduplication. In at least one embodiment, the network accelerator can provide remote direct memory access (RDMA) over Converged Ethernet (RoCE) RoCE, Zero Touch RoCE, Stateless offloads for TCP, IP, and User Datagram Protocol (UDP), Large Receive Offload (LRO), Large Segment Offload (LSO), checksum, Total Sum of Squares (TSS), Residual Sum of Squares (RSS), HTTP dynamic streaming (HDS), and virtual local area network (VLAN) insertion/stripping, single root I/O virtualization (SR-IOV), virtual Ethernet card (e.g., VirtIO-net), Multi-function per port, VMware NetQueue support, Virtualization hierarchies, and ingress and egress Quality of Service (QoS) levels (e.g., 1K ingress and egress QoS levels). In at least one embodiment, the DPU 204 can also provide boot options, including secure boot (RSA authenticated), remote boot over Ethernet, remote boot over Internet Small Computer System Interface (iSCSI), Preboot execution environment (PXE), and Unified Extensible Firmware Interface (UEFI).

In at least one embodiment, the DPU 204 can provide management services, including a 1 GbE out-of-band management port, network controller sideband interface (NC-SI), Management Component Transport Protocol (MCTP) over System Management Bus (SMBus), and Monitoring Control Table (MCT) over PCIe, Platform Level Data Model (PLDM) for Monitor and Control, PLDM for Firmware Updates, Inter-Integrated Circuit (I2C) interface for device control and configuration, Serial Peripheral Interface (SPI) interface to flash, embedded multi-media card (eMMC) memory controller, Universal Asynchronous Receiver/Transmitter (UART), and Universal Serial Bus (USB).

The host device 202 may be a desktop computer, a laptop computer, a smartphone, a tablet computer, a server, or any suitable computing device capable of performing the techniques described herein. In some embodiments, the host device 202 may be a computing device of a cloud-computing platform. For example, the host device 202 may be a server machine of a cloud-computing platform or a component of the server machine. In such embodiments, the host device 202 may be coupled to one or more edge devices (not shown) via the network 210. An edge device refers to a computing device that enables communication between computing devices at the boundary of two networks. For example, an edge device may be connected to host device 202, one or more data stores, one or more server machines via network 210, and may be connected to one or more endpoint devices (not shown) via another network. In such an example, the edge device can enable communication between the host device 202, one or more data stores, one or more server machines, and one or more client devices. In other or similar embodiments, host device 202 may be an edge device or a component of an edge device. For example, host device 202 may facilitate communication between one or more data stores, one or more server machines connected to host device 202 via network 210, and one or more client devices connected to host device 202 via another network.

In still other or similar embodiments, the host device 202 can be an endpoint device or a component of an endpoint device. For example, host device 202 may be, or may be a component of, devices, such as televisions, smartphones, cellular telephones, data center servers, data DPUs, personal digital assistants (PDAs), portable media players, netbooks, laptop computers, electronic book readers, tablet computers, desktop computers, set-top boxes, gaming consoles, a computing device for autonomous vehicles, a surveillance device, and the like. In such embodiments, host device 202 may be connected to the DPU 204 over one or more network interfaces via network 210. In other or similar embodiments, host device 202 may be connected to an edge device (not shown) via another network, and the edge device may be connected to the DPU 204 via network 210.

In at least one embodiment, the host device 202 executes one or more computer programs. One or more computer programs can be any process, routine, or code executed by the host device 202, such as a host OS, an application, a guest OS of a virtual machine, or a guest application, such as executed in a container. host device 202 can include one or more CPUs of one or more cores, one or more multi-core CPUs, one or more GPUs, one or more hardware accelerators, or the like.

FIG. 3 is a network diagram of an example network pipeline 300 that is optimized and accelerated on an acceleration hardware engine of a DPU having an NPAL according to at least one embodiment. The network pipeline 300 includes an input port 302, a filtering network function 304, an ingress port 306, a first network function 308, a bridge 310, a Switched Virtual Interface (SVI) ACLs 312, a router 314, a second network function 316, an egress port 318, and an output port 320. The input port 302 can receive the network traffic data and provide the network traffic data to the filtering network function 304, which is operatively coupled to the input port 302. The filtering network function 304 can filter the network traffic data. In at least one embodiment, the filtering network function 304 includes the CoPP logic 102 as described herein. The ingress port 306 is operatively coupled to the filtering network function 304, and the ingress port 306 is operatively coupled to the first network function 308. The first network function 308 can process the network traffic data using one or more ingress ACLs. The bridge 310 is operatively coupled to the first network function 308. The bridge 310 can perform a Layer-2 (L2) bridging operation. The one or more SVI ACLs are operatively coupled to the bridge 310 and the router 314. The router 314 can perform a Layer-3 (L3) routing operation. The second network function 316 is operatively coupled to the router 314, The second network function 316 can process the network traffic data using one or more egress ACLs. The egress port 318 is operatively coupled to the second network function 316. The egress port 318 is operatively coupled to the output port 320. The output port 320 can output the network traffic data.

FIG. 4 is a network diagram of an example network pipeline that is optimized and accelerated on an acceleration hardware engine of a DPU having an NPAL according to at least one embodiment. The network pipeline 400 includes an input port 402, a filtering network function 404, an ingress port with first network function 406, a second network function 408, a bridge 410, an SVI ACLs 412, a router 414, a third network function 416, an egress port with fourth network function 418, and an output port 420. The input port 402 can receive the network traffic data and provide the network traffic data to the filtering network function 404, which is operatively coupled to the input port 402 with a first filtering network function 404. The filtering network function 404 can filter the network traffic data, providing the network traffic data to the ingress port with the first network function 406. In at least one embodiment, the filtering network function 404 includes the CoPP logic 102 as described herein. The first network function 1306 can perform first virtual local area network (VLAN) mapping on the network traffic data and provide the data to the second network function 408 (or alternatively, the bridge 410). The second network function can process the network traffic data using one or more ingress Access Control Lists (ACLs). The ingress ACLs can be dynamic or static ACLs. The bridge 410 is operatively coupled to the first network function and the second network function 408. The bridge 410 can perform a Layer-2 (L2) bridging operation. The SVI ACLs are operatively coupled to the bridge 410 and the router 414. The router 414 can perform a Layer-3 (L3) routing operation. The third network function 416 is operatively coupled to the router 414. The third network function 416 can process the network traffic data using one or more egress ACLs. The egress ACLs can be dynamic or static. The egress port with fourth network function 418 is operatively coupled to the third network function 416. The fourth network function can perform a second VLAN mapping on the network traffic data. The output port 420 is operatively coupled to the egress port with the fourth network function 418. The output port 420 can output the network traffic data.

FIG. 5 is a network diagram of an example network pipeline 500 that is optimized and accelerated on an acceleration hardware engine of a DPU having an NPAL according to at least one embodiment. The network pipeline 500 includes an input port 502, a first network function 504, a second network function 506, a third network function 508, a fourth network function 510, a fifth network function 512, a sixth network function 514, a seventh network function 516, and an output port 518. In at least one embodiment, the first network function 504 includes the CoPP logic 102 as described herein. The network pipeline 500 can include any combination of network functions in a specified order, each network function including logic and/or tables to implement the respective network function and pass the network traffic data to the subsequent network function. In at least one embodiment, the first network function 504 can perform Layer-2 (L2) bridging, the second network function 506 can perform Layer-3 (L3) routing, the third network function 508 can perform tunnel encapsulation or tunnel decapsulation, the fourth network function 510 can perform a hash calculation, the fifth network function 512 can perform an ECMP operation, the sixth network function 514 can perform a CT operation, and the seventh network function 516 can perform a NAT operation. Alternatively, the network pipeline 500 can include different numbers and different types of network operations between the input port 502 and output port 518.

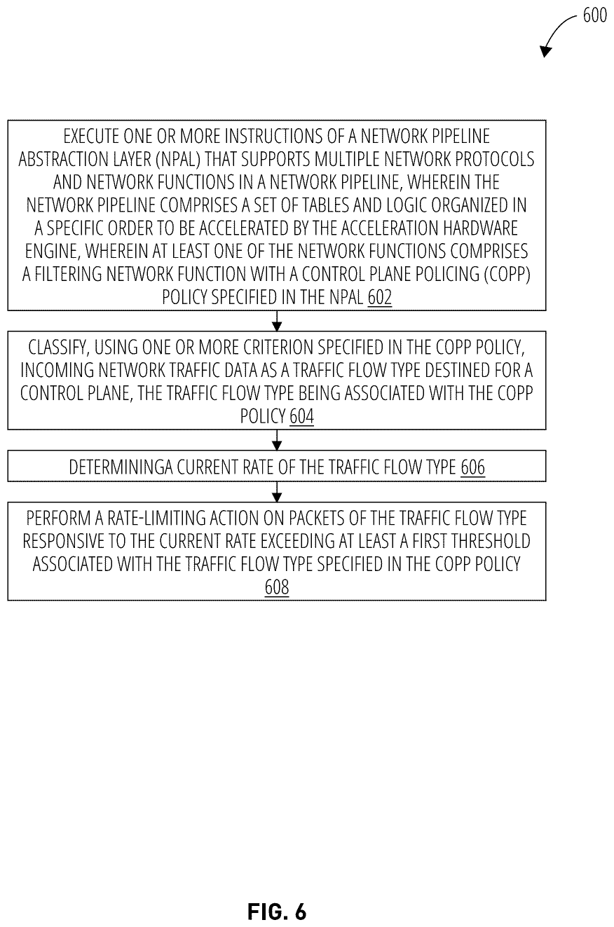

FIG. 6 is a flow diagram of an example method 600 of rate limiting incoming network traffic data directed to a control plane using a network pipeline abstraction layer (NPAL) with CoPP support according to at least one embodiment. The processing logic can be a combination of hardware, firmware, software, or any combination thereof. In at least one embodiment, the processing logic is implemented in a DPU, a switch, a network device, a GPU, a NIC, a CPU, or the like. In at least one embodiment, the processing logic is implemented in an acceleration hardware engine coupled to a switch. In at least one embodiment, method 600 may be performed by multiple processing threads, each thread executing one or more individual functions, routines, subroutines, or operations of the method. In at least one embodiment, processing threads implementing method 600 may be synchronized (e.g., using semaphores, critical sections, and/or other thread synchronization logic). Alternatively, processing threads implementing method 600 may be executed asynchronously with respect to each other. Various operations of method 600 may be performed differently than the order shown in FIG. 6. Some operations of the methods may be performed concurrently with other operations. In at least one embodiment, one or more operations shown in FIG. 6 may not always be performed. In at least one embodiment, the method 600 is performed by the integrated circuit 100, processing device 108, or CoPP logic 102 of FIG. 1. In at least one embodiment, the method 600 is performed by the computing system 200, DPU 204, DPU hardware 208, of FIG. 2. integrated circuit 100, processing device 108, or CoPP logic 102 of FIG. 1. In at least one embodiment, the method 600 is performed by the network pipeline 300 of FIG. 3, the network pipeline 400 of FIG. 4, or the network pipeline 500 of FIG. 5.

Referring to FIG. 6, the method 600 begins with the processing logic executing one or more instructions of a network pipeline abstraction layer (NPAL) that supports multiple network protocols and network functions in a network pipeline (block 602). The network pipeline includes a set of tables and logic organized in a specific order to be accelerated by the acceleration hardware engine. At least one of the network functions comprises a filtering network function with a CoPP policy specified in the NPAL. At block 604, the processing logic classifies, using one or more criterion specified in the CoPP policy, incoming network traffic data as a traffic flow type destined for a control plane, the traffic flow type being associated with the CoPP policy. At block 608, the processing logic determines the current rate of the traffic flow type. At block 608, the processing logic performs a rate-limiting action on packets of the traffic flow type responsive to the current rate exceeding at least a first threshold associated with the traffic flow type specified in the CoPP policy.

In at least one embodiment, the network pipeline includes the ports and network functions described above with respect to FIG. 3, FIG. 4, and FIG. 5.

In a further embodiment, the processing logic determines whether there is congestion from the incoming network traffic data. At block 608, the processing logic can forward the packets of the traffic flow type responsive to there being no congestion and the current rate exceeds the first threshold; or the processing logic can drop or mark the packets with a lower priority than other packets responsive to there being congestion and the current rate exceeds the first threshold. In at least one embodiment, the first threshold is a CIR.

In a further embodiment, In a further embodiment, the processing logic determines whether there is congestion from the incoming network traffic data. At block 608, the processing logic can forward the packets of the traffic flow type responsive to i) there being no congestion, ii) the current rate exceeds the first threshold, and iii) the current rate does not exceed a second threshold associated with the traffic flow type specified in the CoPP policy. Or, at block 608, the processing logic can drop or mark the packets with a lower priority than other packets responsive to i) there being congestion, ii) the current rate exceeds the first threshold, and iii) the current rate does not exceed the second threshold. Or, at block 608, the processing logic can drop the packets responsive to the current rate exceeding the second threshold. In at least one embodiment, the first threshold is a CIR and the second threshold is EIR.

In at least one embodiment, at block 604, the processing logic classifies the incoming network traffic data as the traffic flow type destined for the control plane by identifying an attribute in packet headers of the incoming network traffic data. The attribute can be any attribute in a packet header. The attribute can be a destination IP address, a L4 destination port, a physical port, or the like.

### NPAL Supporting COPP

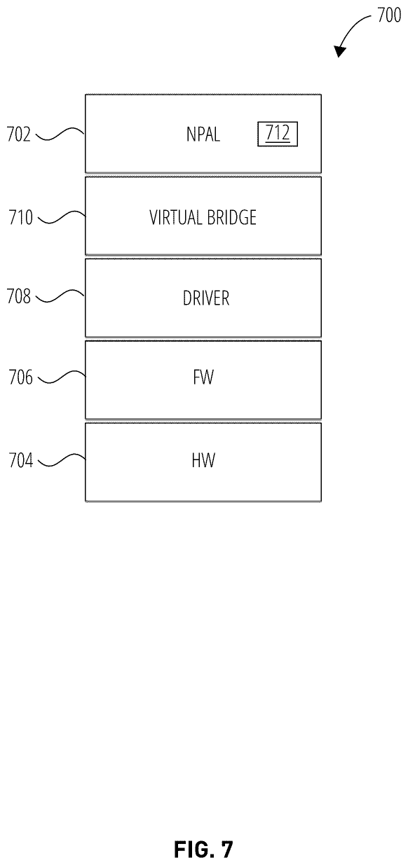

FIG. 7 is a block diagram of a software stack 700 of a DPU with an NPAL 702 that supports CoPP according to at least one embodiment. As described above, to support CoPP, the DPU needs to support it in both hardware and software. From the hardware perspective, the DPU hardware includes a network interconnect coupled to a network, a host interconnect coupled to a host device, and an acceleration hardware engine. The DPU hardware can include additional hardware, such as a processing device (e.g., one or more CPU cores), one or more GPUs, switches, memory, or the like.

From the software perspective, the software stack 700 can support CoPP. The software stack 700 can be stored in a memory of the DPU. The software stack 700 includes firmware 706, driver 708, virtual bridge 710, and NPAL 702. The firmware 706 can interact with the DPU hardware 704 and the driver 708. The driver 708 can interact with the firmware 706 and the virtual bridge 710. The NPAL 702 can sit on top of the virtual bridge 710. The software stack 700 can be made up of instructions that when executed by the DPU hardware can provide the NPAL 702 that supports multiple network protocols and network functions in a network pipeline, including CoPP in a filtering network function. As described above, the network pipeline includes a set of tables and logic organized in a specific order to be accelerated by the acceleration hardware engine.

The NPAL 702 can configure different policies, including a CoPP policy 712. As described herein, the NPAL 702 includes a set of APIs or classes that provide a unified interface to one or more applications executed by the processing device or a host device coupled to the DPU. The NPAL 702 can be used to define the different policies for different control protocols. The NPAL 702 can be used to configure the network pipeline to perform one or more network functions, including a filtering network function that support CoPP. In at least one embodiment, the different network functions can include L2 bridging, L3 routing, tunnel encapsulation, tunnel decapsulation, hash calculations, ECMP operations, static and dynamic ACLs, CT, etc. Similarly, different network functions can be performed. Once configured, the DPU hardware can process the network traffic data using the network pipeline.

In at least one embodiment, the network pipeline includes an input port to receive the network traffic data over a physical port. The network pipeline includes a filtering network function operatively coupled to the input port, the filtering network function to filter the network traffic data according to the CoPP policy 712. The network pipeline includes an ingress port operatively coupled to the filtering network function, and a first network function operatively coupled to the ingress port, the first network function to process the network traffic data using one or more ingress Access Control Lists (ACLs). The network pipeline includes a bridge operatively coupled to the first network function, the bridge to perform a L2 bridging operation, and one or more SVI ACLs (e.g., static or dynamic) operatively coupled to the bridge. The network pipeline includes a router operatively coupled to the SVI ACLs (e.g., static or dynamic), the router to perform a L3 routing operation. The network pipeline includes a second network function operatively coupled to the router, the second network function to process the network traffic data using one or more egress ACLs. The network pipeline includes an egress port operatively coupled to the second network function, and an output port to output the network traffic data.

In at least one embodiment, the network pipeline includes an input port to receive the network traffic data over the physical port. The network pipeline includes a filtering network function operatively coupled to the input port, the filtering network function to filter the network traffic data according to the CoPP policy 712. The network pipeline includes an ingress port operatively coupled to the filtering network function, the ingress port having a first network function to perform first VLAN mapping on the network traffic data. The network pipeline includes a second network function operatively coupled to the ingress port, the second network function to process the network traffic data using one or more ingress ACLs. The network pipeline includes a bridge operatively coupled to the second network function, the bridge to perform a L2 bridging operation, and one or more SVI ACLs (e.g., static or dynamic) operatively coupled to the bridge. The network pipeline includes a router operatively coupled to the SVI ACLs (e.g., static or dynamic), the router to perform a Layer-3 (L3) routing operation. The network pipeline includes a third network function operatively coupled to the router, the third network function to process the network traffic data using one or more egress ACLs. The network pipeline includes an egress port operatively coupled to the third network function, the egress port having a fourth network function to perform second VLAN mapping on the network traffic data. The network pipeline includes an output port to output the network traffic data.

In at least one embodiment, the network pipeline includes two or more of the following network functions: a first network function to perform L2 bridging; a second network function to perform L3 routing; a third network function to perform tunnel encapsulation or tunnel decapsulation; a fourth network function to perform a hash calculation; a fifth network function to perform an ECMP operation; a sixth network function to perform a CT operation; or a seventh network function to perform a NAT operation. An example network pipeline is illustrated and described above with respect to FIG. 3, FIG. 4, and FIG. 5.

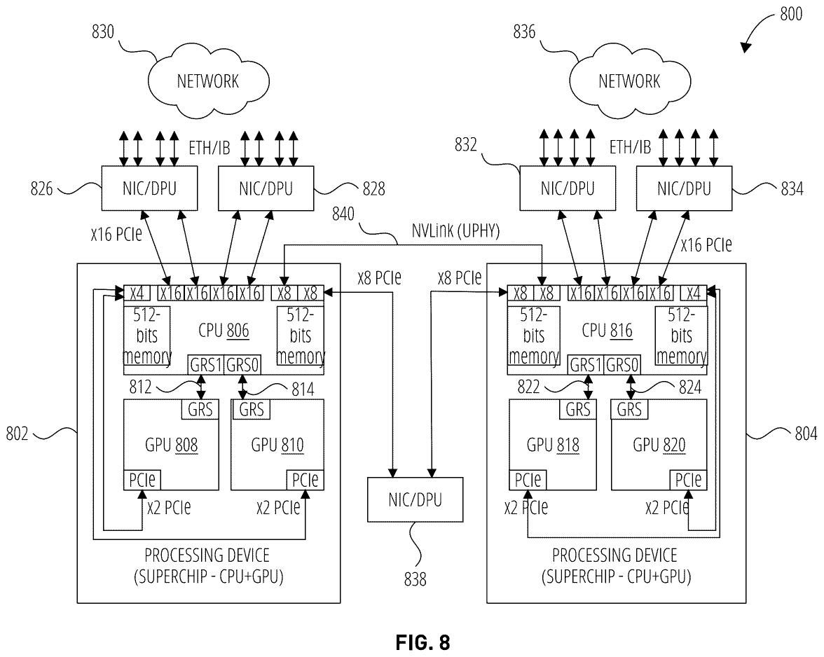

FIG. 8 is a block diagram of a computing system 800 having two processing devices coupled to each other and multiple networks according to at least one embodiment. The computing system 800 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 800. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 800 highly suitable for demanding applications that require significant processing power, such as artificial intelligence (AI), machine learning (ML), and data-intensive computing, while ensuring robust connectivity and scalability across various networked environments. The integrated circuits of the computing system 800 can include one or more CPUs and one or more GPUs. An example architecture of a multi-GPU architecture is illustrated in FIG. 8.

As illustrated in FIG. 8, the computing system 800 includes a processing device 802 with a multi-GPU architecture. In particular, the processing device 802 includes a CPU 806, a GPU 808, and a GPU 810. The CPU 806 can be coupled to the GPU 808 via an die-to-die (D2D) or chip-to-chip (C2C) interconnect 812, such as a Ground-Referenced Signaling interconnect (GRS interconnect). The CPU 806 can be coupled to the GPU 810 via a D2D or C2C interconnect 814. The CPU 806 can also be coupled to the GPU 808 and GPU 810 via PCIe interconnects. The CPU 806 can be coupled to one or more network interface cards (NICs) or data processing units (DPUs), which are coupled to one or more networks. For example, as illustrated in FIG. 8, the CPU 806 is coupled to a first NIC/DPU 826, which is coupled to a network 830. The CPU 806 is also coupled to a second NIC/DPU 828, which is coupled to the network 830. The NIC/DPU 826 and NIC/DPU 828 can be coupled to the network 830 over Ethernet (ETH) or InfiniBand (IB) connections.

The computing system 800 also includes a processing device 804 with a multi-GPU architecture. In particular, the processing device 804 includes a CPU 816, a GPU 818, and a GPU 820. The CPU 816 can be coupled to the GPU 818 via an D2D or C2C interconnect 822. The CPU 816 can be coupled to the GPU 820 via a D2D or C2C interconnect 824. The CPU 816 can also be coupled to the GPU 818 and GPU 820 via PCIe interconnects. The CPU 816 can be coupled to one or more NICs or DPUs, which are coupled to one or more networks. For example, as illustrated in FIG. 8, the CPU 816 is coupled to a first NIC/DPU 832, which is coupled to a network 836. The CPU 816 is also coupled to a second NIC/DPU 834, which is coupled to the network 836. The NIC/DPU 832 and NIC/DPU 834 can be coupled to the network 836 over Ethernet (ETH) or InfiniBand (IB) connections.

In at least one embodiment, the processing device 802 and the processing device 804 can communicate with each other via a NIC/DPU 838, such as over PCIe interconnects. The processing device 802 and processing device 804 can also communicate with each other over a high-bandwidth communication interconnects 840, such as an NVLink interconnect or other high-speed interconnects.

The NIC/DPUs of FIG. 8 can be the various embodiments of the DPUs described herein with respect to FIG. 1 to FIG. 9.

In at least one embodiment, the computing system 800 is used for high-speed network communication and includes a processing unit (e.g., CPU 806, GPU 808, GPU 810, CPU 816, GPU 818, GPU 820, NIC/DPU 826, NIC/DPU 828, NIC/DPU 832, NIC/DPU 834, or NIC/DPU 838), and a network interface coupled to the processing unit. The network interface can include the operations and functionality of the DPUs described herein.

In at least one embodiment, the computing system 800 includes a host device and an auxiliary device. The auxiliary device includes a device memory and a processor, communicably coupled to the device memory. The auxiliary device performs the operations described herein with respect to FIG. 1 to FIG. 9. The auxiliary device can include a GPU. The auxiliary device can include a DPU. The auxiliary device can include a DPU. The auxiliary device can include accelerator hardware.

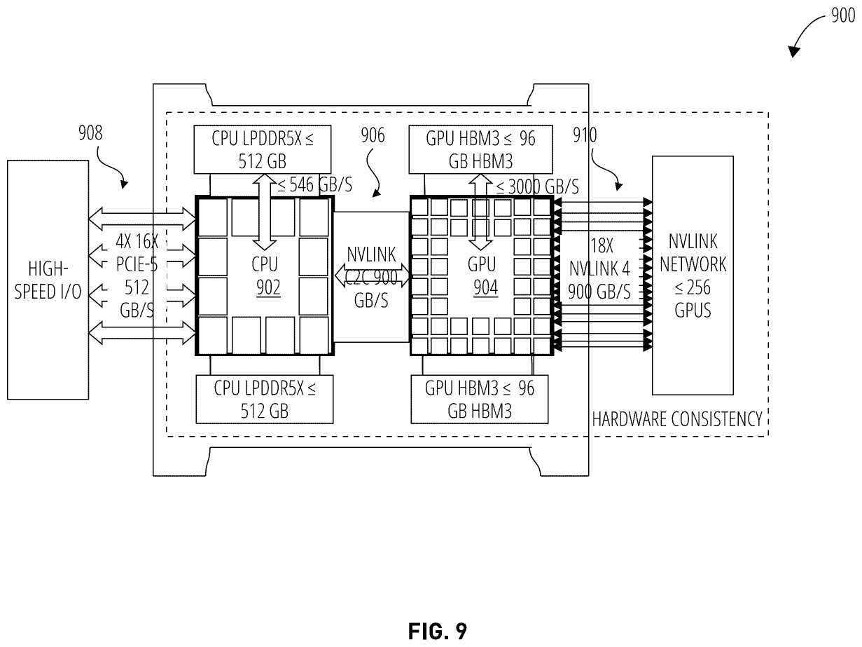

FIG. 9 is a block diagram of a computing system 900 having a CPU 902 and a GPU 904 in a single integrated circuit according to at least one embodiment. The computing system 900 can be a highly integrated design where a CPU 902 and GPU 904 are connected on a single integrated circuit, utilizing an NVLink C2C (Chip-to-Chip) interconnect 906 to enable fast, low-latency communication between the two processing units. This close integration allows for efficient data transfer and parallel processing between the CPU 902 and GPU 904, optimizing performance for complex computational tasks. The GPU elements within the computing system 900 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 910. Additionally, the computing system 900 can be designed to interface with a high-speed I/O through PCIe interconnects 908, ensuring rapid data transfer to and from external devices, further enhancing the system's capabilities in handling data-intensive tasks and providing robust connectivity to peripheral components. It should be noted that the C2C interconnects 906 can be considered D2D interconnects since the CPU 902 and the GPU 904 are located on the same integrated circuit. The integrated circuit can include CPU memory (also referred to as main memory) and GPU memory, which are accessible by the CPU 902 and the GPU 904, respectively, over high-speed interconnects. The computing system 900 can bring together performance of the GPU 904 with the versatility of the CPU 902. The CPU 902 can be connected with a high-bandwidth and memory coherent C2C interconnects 906 in a single integrated circuit. The computing system 900 can support a link switch system.

The computing system 900 can be used for the various embodiments described herein with respect to FIG. 1 to FIG. 9.

In at least one embodiment, the computing system 900 is used for high-speed network communication and includes a processing unit, and a network interface coupled to the processing unit. The network interface can include the operations and functionality of the DPUs described herein.

In at least one embodiment, the computing system 900 includes a host device and an auxiliary device. The auxiliary device includes a device memory and a processor, communicably coupled to the device memory. The auxiliary device performs the operations described herein with respect to FIG. 1 to FIG. 9. The auxiliary device can include a GPU. The auxiliary device can include a DPU. The auxiliary device can include a DPU. The auxiliary device can include accelerator hardware.

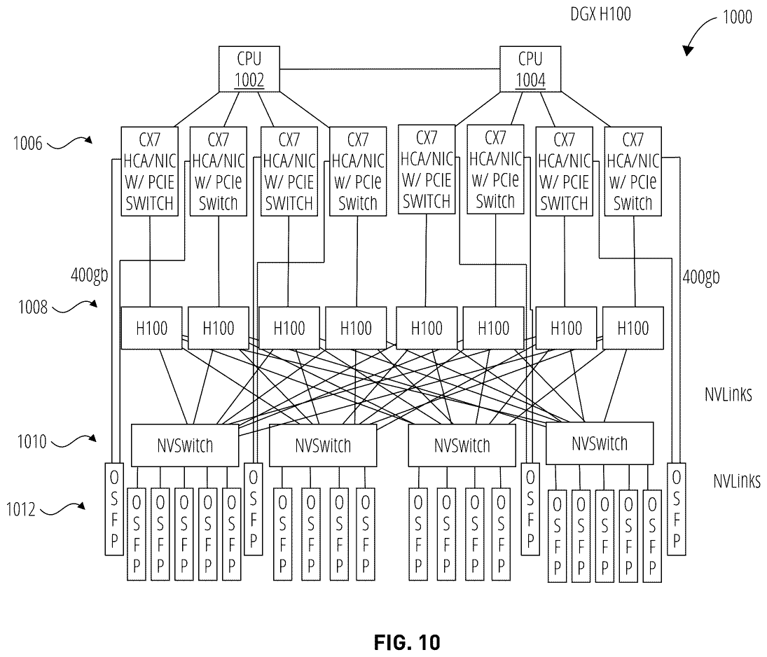

FIG. 10 is a block diagram of a computing system 1000 having tensor core GPUs 1008 according to at least one embodiment. The computing system 1000 can be a DGX H100 system, which is a high-performance computing platform designed to meet the demands of AI, ML, and deep learning (DL) workloads. The computing system 1000 can include multiple tensor core GPUs 1008 (e.g., NVIDIA H100 Tensor Core GPUs). The tensor core GPUs 1008 can each be one of the integrated circuits described above with respect to FIG. 9. The tensor core GPUs 1008 can be optimized for AI/ML/DL applications, offering exceptional performance for deep learning training, inference, and high-performance computing tasks. The tensor core GPUs 1008 within the computing system 1000 are interconnected using high-speed communication interfaces like NVLinks, enabling rapid data transfer between them, which is crucial for handling large-scale AI models and datasets with low latency. This computing system 1000 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1008, the computing system 1000 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1008 for their specific applications. The computing system 1000 is ideally suited for large-scale AI model training, real-time inference, scientific simulations, data analytics, and other compute-intensive tasks that require massive parallel processing power.

The tensor core GPUs 1008 can be coupled to multiple CPUs, such as CPU 1002 and CPU 1004, using switches 1006 (e.g., CX7 HCA/NIC with PCIe switch). The tensor core GPUs 1008 can be coupled to each other via switches 1010 (e.g., NVSwitches). The switches 1006 and switches 1010 can be coupled to high-speed transceiver modules 1012. The high-speed transceiver modules 1012 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1000 remains capable of meeting increasing data demands and can be upgraded to support future advancements in network speeds, thus contributing to the system's overall performance and scalability.

In at least one embodiment, the computing system 1000 can be considered a data-network configuration with full-bandwidth intra-server NVLinks. In this example, all eight tensor core GPUs 1008 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1008 can half-subscribe eighteen NVLinks to GPUs in other servers. Four tensor core GPUs 1008 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1008 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The NICs/switches of computing system 1000 can include the various embodiments described herein with respect to FIG. 1 to FIG. 9.

In at least one embodiment, the computing system 1000 is used for high-speed network communication and includes a processing unit (e.g., CPU 1002, CPU 1004, switches 1006, tensor core GPUs 1008, switches 1010, high-speed transceiver modules 1012), and a network interface coupled to the processing unit. The network interface can include the operations and functionality of the DPUs described herein.

In at least one embodiment, the computing system 1000 includes a host device and an auxiliary device. The auxiliary device includes a device memory and a processor, communicably coupled to the device memory. The auxiliary device performs the operations described herein with respect to FIG. 1 to FIG. 9. The auxiliary device can include a GPU. The auxiliary device can include a DPU. The auxiliary device can include a DPU. The auxiliary device can include accelerator hardware.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within range unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., may be either A or B or C, or any nonempty subset of a set of A and B and C. For instance, in the illustrative example of a set having three members, conjunctive phrases “at least one of A, B, and C” and “at least one of A, B, and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in at least one embodiment, comprises multiple non-transitory computer-readable storage media, and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors—for example, a non-transitory computer-readable storage medium stores instructions, and a main CPU executes some of the instructions while a GPU executes other instructions. In at least one embodiment, different components of a computer system have separate processors, and different processors execute different subsets of instructions.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that the distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The terms “coupled” and “connected,” along with their derivatives, may be used in the description and claims. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but yet still CO-operate or interact with each other.

Unless specifically stated otherwise, it may be appreciated that throughout specification terms such as “processing,” “computing,” “calculating,” “determining,” or like, refer to action and/or processes of a computer or computing system or similar electronic computing devices, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes for carrying out instructions in sequence or parallel, continuously, or intermittently. The terms “system” and “method” are used herein interchangeably as far as a system may embody one or more methods, and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or inter-process communication mechanism.

Although the discussion above sets forth example implementations of described techniques, other architectures may be used to implement the described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A data processing unit (DPU) comprising:
DPU hardware comprising a processing device and an acceleration hardware engine; and
a memory operatively coupled to the DPU hardware, the memory to store instructions that, when executed by the DPU hardware, are to provide a network pipeline abstraction layer (NPAL) that supports multiple network protocols and network functions in a network pipeline, wherein the network pipeline comprises a set of tables and logic organized in a specific order to be accelerated by the acceleration hardware engine, wherein at least one of the network functions comprises a filtering network function with a control plane policing (CoPP) policy specified in the NPAL, wherein the filtering network function is to:
classify, using one or more criterion specified in the CoPP policy, incoming network traffic data as a traffic flow type destined for a control plane, the traffic flow type being associated with the CoPP policy;
determine a current rate of the traffic flow type; and
perform a rate-limiting action on packets of the traffic flow type responsive to the current rate exceeding a first threshold associated with the traffic flow type specified in the CoPP policy.

2. The DPU of claim 1, wherein:
the filtering network function is further to determine whether there is congestion from the incoming network traffic data; and
the filtering network function, to perform the rate-limiting action on the packets comprises:
forward the packets of the traffic flow type responsive to there being no congestion and the current rate exceeds the first threshold; or
drop the packets or mark the packets with a lower priority than other packets responsive to there being congestion and the current rate exceeds the first threshold.

3. The DPU of claim 2, wherein the first threshold is a Committed Information Rate (CIR).

4. The DPU of claim 1, wherein:
the filtering network function is further to determine whether there is congestion from the incoming network traffic data; and
the filtering network function, to perform the rate-limiting action on the packets comprises:
forward the packets of the traffic flow type responsive to i) there being no congestion, ii) the current rate exceeds the first threshold, and iii) the current rate does not exceed a second threshold associated with the traffic flow type specified in the CoPP policy; or
drop the packets or mark the packets with a lower priority than other packets responsive to i) there being congestion, ii) the current rate exceeds the first threshold, and iii) the current rate does not exceed the second threshold; or
drop the packets responsive to the current rate exceeding the second threshold.

5. The DPU of claim 4, wherein the first threshold is a Committed Information Rate(CIR) and the second threshold is an Excess Information Rate (EIR).

6. The DPU of claim 1, wherein, to classify the incoming network traffic data as the traffic flow type destined for the control plane, the filtering network function is to identify an attribute in packet headers of the incoming network traffic data.

7. The DPU of claim 6, wherein the attribute comprises at least one of:
a destination Internet Protocol (IP) address;
a Layer-4 destination port; or
a physical port.

8. A computing system comprising:
a host device; and
an integrated circuit coupled to the host device and a network, wherein the integrated circuit comprises:
a network interconnect coupled to the network;
a host interconnect coupled to the host device;
an acceleration hardware engine;
a memory to store instructions that, when executed by the integrated circuit, are to provide a network pipeline abstraction layer (NPAL) that supports multiple network protocols and network functions in a network pipeline, wherein the network pipeline comprises a set of tables and logic organized in a specific order to be accelerated by the acceleration hardware engine, wherein at least one of the network functions comprises a filtering network function with a control plane policing (CoPP) policy specified in the NPAL, wherein the filtering network function is to:
classify, using one or more criterion specified in the CoPP policy, incoming network traffic data as a traffic flow type destined for a control plane, the traffic flow type being associated with the CoPP policy;
determine a current rate of the traffic flow type; and
perform a rate-limiting action on packets of the traffic flow type responsive to the current rate exceeding at least a first threshold associated with the traffic flow type specified in the CoPP policy.

9. The computing system of claim 8, wherein the integrated circuit is at least one of a data processing unit (DPU), a network interface card (NIC), a network interface device, or a switch, wherein the DPU is a programmable data center infrastructure on a chip.

10. The computing system of claim 8, wherein the NPAL comprises a set of applications programming interfaces (APIs) or classes that provide a unified interface to one or more applications executed by the integrated circuit or a host device coupled to the integrated circuit.

11. The computing system of claim 8, wherein:
the filtering network function is further to determine whether there is congestion from the incoming network traffic data;
the filtering network function, to perform the rate-limiting action on the packets comprises:
forward the packets of the traffic flow type responsive to there being no congestion and the current rate exceeds the first threshold; or
drop the packets or mark the packets with a lower priority than other packets responsive to there being congestion and the current rate exceeds the first threshold; and the first threshold is a Committed Information Rate (CIR).

12. The computing system of claim 8, wherein:
the filtering network function is further to determine whether there is congestion from the incoming network traffic data; and
the filtering network function, to perform the rate-limiting action on the packets comprises:
forward the packets of the traffic flow type responsive to i) there being no congestion, ii) the current rate exceeds the first threshold, and iii) the current rate does not exceed a second threshold associated with the traffic flow type specified in the CoPP policy; or
drop the packets or mark the packets with a lower priority than other packets responsive to i) there being congestion, ii) the current rate exceeds the first threshold, and iii) the current rate does not exceed the second threshold; or
drop the packets responsive to the current rate exceeding the second threshold; and
the first threshold is a Committed Information Rate (CIR) and the second threshold is an Excess Information Rate (EIR).

13. The computing system of claim 8, wherein, to classify the incoming network traffic data as the traffic flow type destined for the control plane, the filtering network function is to identify an attribute in packet headers of the incoming network traffic data.

14. The computing system of claim 13, wherein the attribute comprises at least one of:
a destination Internet Protocol (IP) address;
a Layer-4 destination port; or
a physical port.

15. A method of operating a data processing unit (DPU), the method comprising:
executing one or more instructions of a network pipeline abstraction layer (NPAL) that supports multiple network protocols and network functions in a network pipeline, wherein the network pipeline comprises a set of tables and logic organized in a specific order to be accelerated by an acceleration hardware engine, wherein at least one of the network functions comprises a filtering network function with a control plane policing (CoPP) policy specified in the NPAL;
classifying, using one or more criterion specified in the CoPP policy, incoming network traffic data as a traffic flow type destined for a control plane, the traffic flow type being associated with the CoPP policy;
determining a current rate of the traffic flow type; and
performing a rate-limiting action on packets of the traffic flow type responsive to the current rate exceeding at least a first threshold associated with the traffic flow type specified in the CoPP policy.

16. The method of claim 15, further comprising determining whether there is congestion from the incoming network traffic data, and wherein performing the rate-limiting action on the packets comprises:
forwarding the packets of the traffic flow type responsive to there being no congestion and the current rate exceeds the first threshold; or
dropping the packets or marking the packets with a lower priority than other packets responsive to there being congestion and the current rate exceeds the first threshold.

17. The method of claim 16, wherein the first threshold is a Committed Information Rate (CIR).

18. The method of claim 15, further comprising determining whether there is congestion from the incoming network traffic data, and wherein performing the rate-limiting action on the packets comprises:
forwarding the packets of the traffic flow type responsive to i) there being no congestion, ii) the current rate exceeds the first threshold, and iii) the current rate does not exceed a second threshold associated with the traffic flow type specified in the CoPP policy; or
dropping the packets or marking the packets with a lower priority than other packets responsive to i) there being congestion, ii) the current rate exceeds the first threshold, and iii) the current rate does not exceed the second threshold; or
dropping the packets responsive to the current rate exceeding the second threshold.

19. The method of claim 18, wherein the first threshold is a Committed Information Rate(CIR) and the second threshold is an Excess Information Rate (EIR).

20. The method of claim 18, wherein classifying the incoming network traffic data as the traffic flow type destined for the control plane comprises identifying an attribute in packet headers of the incoming network traffic data, wherein the attribute comprises at least one of:
a destination Internet Protocol (IP) address;
a Layer-4 destination port; or
a physical port.
